(19) United States
(12) Patent Application Publication
(10) Pub. No.: US 2008/0226152 A1
(43) Pub. Date: Sep. 18, 2008

(54) Determining Image Blur in an Imaging System

(75) Inventors: Peter Dirksen, Leuven (BE); Augustus Josephus Elizabeth Maria Janssen, Eindhoven (NL); Josephus Johannes Maria Braat, Eindhoven (NL); Adriaan Leeuwestein, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,035

(22) PCT Filed: Feb. 8, 2005
(86) PCT No.: PCT/IB05/50496

§ 371 Date: Aug. 16, 2006

(30) Foreign Application Priority Data
Feb. 23, 2004 (EP) 04100696.6

(51) Int. Cl. G06K 9/00

(52) U.S. Cl. 382/141

(57) ABSTRACT

The invention relates to a method of determining a parameter relating to image blur in an imaging system (IS) comprising the step of illuminating an object having a test pattern (MTP) by means of the imaging system (IS), thereby forming an image of the test pattern. The test pattern (MTP) has a size smaller than the resolution of the imaging system (IS), which makes the image of the test pattern independent of illuminator aberrations. The test pattern (MTP) is an isolated pattern, which causes the image to be free of optical proximity effects. The image is blurred due to stochastic fluctuations in the imaging system and/or in the detector detecting the blurred image. The parameter relating to the image blur is determined from a parameter relating to the shape of the blurred image. According to the invention, resist diffusion and/or focus noise may be characterized. In the method of designing a mask, the parameter relating to the image blur due to diffusion in the resist is taken into account. The computer program according to the invention is able to execute the step of determining the parameter relating to the image blur from a parameter relating to a shape of the blurred image.

The invention relates to determining a parameter relating to image blur in an imaging system.

The invention further relates to designing a mask for use in a lithography process.

The invention further relates to a computer program for executing the method of determining the parameter relating to image blur in an imaging system.

The invention relates to a device for determining a parameter relating to image blur in an imaging system.

A method of determining a parameter relating to image blur in an imaging system is disclosed in Great Britain patent application GB-A-2,320,768. In the known method a process parameter of a lithography process for forming a pattern in a resist layer is determined. The known method comprises the steps of illuminating the resist layer via a mask having a mask pattern by means of an imaging system, developing the illuminated resist layer, thereby forming a pattern, and determining the process parameter from the shape of the pattern.

In a lithography process, the illuminated parts of the resist layer are chemically modified whereas the non-illuminated parts of the resist layer are not chemically modified. In the developing step, ideally either the illuminated parts are dissolved and the non-illuminated parts remain, such a resist is often referred to as a negative resist, or the non-illuminated parts are dissolved and the illuminated parts remain, such a resist is often referred to as a positive resist.

In general, the step of developing the resist layer is not ideal, i.e. close to the interface between the illuminated part and the non-illuminated part of the resist layer some parts of the resist layer may be removed while ideally they should not be removed, or some parts of the resist layer may not be removed while ideally they should be removed. This leads to a blur of the image formed in the resist. The extent to which this non-ideality occurs depends on process conditions in the lithography process such as the chemical composition of the resist, the chemical composition of the developer, the temperature at which the developing step is executed, and the duration of the developing step.

When the resist is a so-called chemical amplification resist (CAR), it comprises a photo acid generator, i.e. a compound which upon absorption of a photon releases an acid. This acid is stimulated to diffuse during a so-called post exposure bake (PEB). During the diffusion the acid interacts chemically with sites in the resist, thereby locally changing the solubility of the resist. One acid may modify several sites in the resist and/or it may generate during the chemical interaction an additional acid which diffuses as well. In this way a single absorbed photon may modify several sites in the resist, leading to so-called chemical amplification. These sites with changed solubility may be all within the diffusion range of the acid. Often the resist comprises traps to trap the acid, thereby restricting the diffusion range. This type of diffusion may at least partly lead to the non-ideality described above.

In advanced lithography processes, the features formed may be so small that these deviations from the ideal situation lead to unacceptable results. In a positive resist, two separate features that are relatively close to each other may be interconnected after the developing step while they are separated on the mask and, due to the optical resolution of the imaging system, should be well separated after the development. In integrated circuit (IC) manufacturing this may lead to short-circuits. On the other hand, in a negative resist a narrow part of a feature, such as a line, may disappear after the development while it is on the mask and, due to the optical resolution of the imaging system, should be in the resist after the development. In IC manufacturing this may lead to open circuits.

In the known method, the pattern expected after illuminating the resist layer via the mask and after developing is estimated in the following way: the Fourier transform of the aerial image of the mask pattern is multiplied by a term accounting for the diffusion in the resist layer, and the result of this operation is inverse Fourier transformed to obtain the expected pattern after developing.

The term accounting for the diffusion in the resist layer is obtained by a fitting procedure. For the fitting procedure various types of mask patterns are used. The mask patterns are isolated lines, lines and spaces, and isolated spaces. For each type of mask patterns at least two different mask pattern sizes are used. For each of the mask patterns different parts of the resist layer or different resist layers are illuminated using various exposure doses. After the development step the size of the pattern in the resist layer is determined for each of the mask patterns and each of the exposure doses. This set of pattern sizes in the resist layer is fit to determine a parameter relating to the diffusion process in the resist layer.

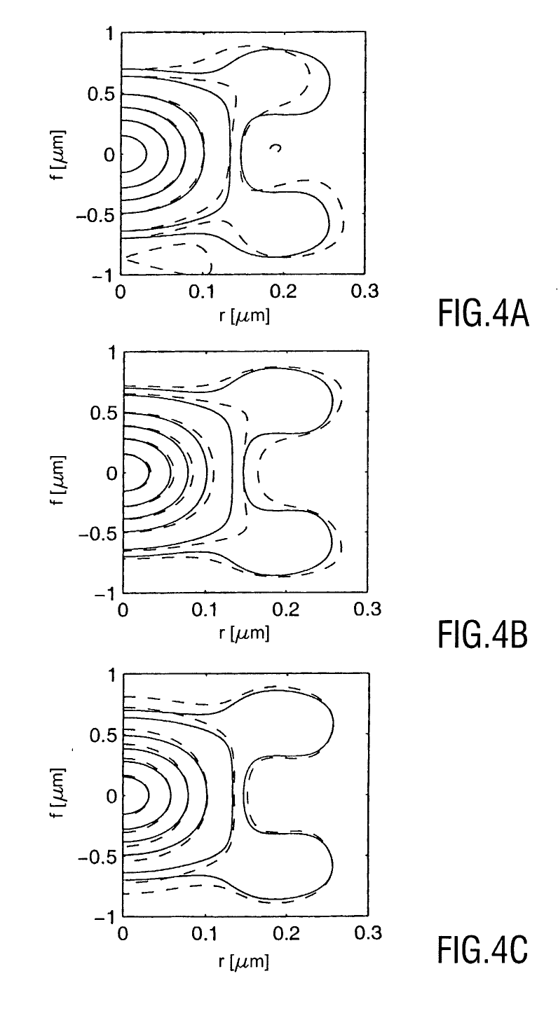

When in the known method only one mask pattern size is used at various doses and/or only one type of pattern, the fitting procedure is not reliable as is indicated e.g. in FIGS. 4A and 4B of GB-A-2,320,768. There it is shown that the known method is able to describe the results for one mask pattern size but fails to describe the results for another mask pattern size. The known method requires observation of various feature sizes and features to characterize the diffusion process in the resist layer.

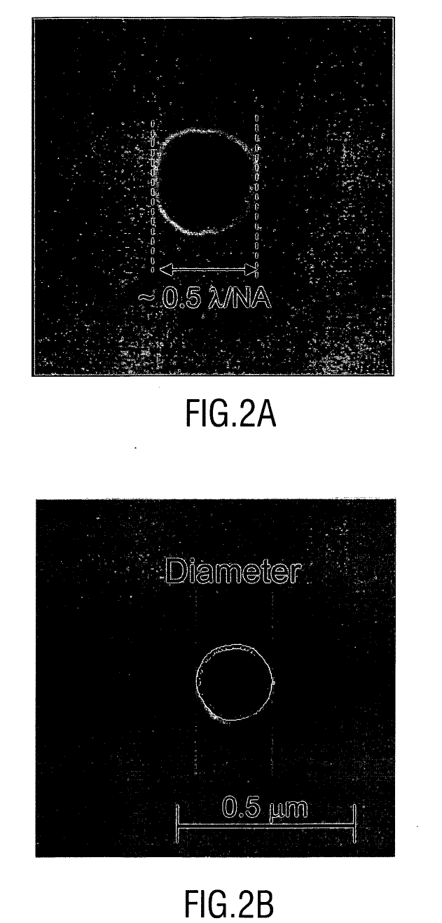

The pattern size in the aerial image is different for the isolated lines, the lines and spaces, and the isolated spaces when the corresponding mask patterns have the same size. In the example of FIG. 2 of GB-A-2,320,768, the smallest and the largest pattern size in the aerial image are obtained for lines and spaces, and for isolated spaces, respectively. The size of the corresponding patterns in the resist depends on the exposure dose.

It is a disadvantage of the known method that it is rather complicated. It requires various types of mask patterns and various mask pattern sizes to determine the parameter relating to the diffusion process in the resist. Moreover, the known method requires a detailed understanding of the imaging system used for illuminating the resist layer via the mask because the aerial images for the various patterns depend on the conditions of the imaging system, the mask pattern size and the type of mask pattern. These conditions of the imaging system have to be taken into account in the fitting procedure but are often not known.

It is an object of the invention to provide a way of determining a parameter relating to image blur in an imaging system which is less complicated.

The invention is defined by the independent claims. The dependent claims define advantageous embodiments.

Here, the size of the test pattern refers to the maximum lateral dimension, and the resolution of the imaging system refers to the minimum distance between two points in the object plane the images of which can still be separated in the image plane of best focus. The imaging system may have a numerical aperture NA, a radiation with a wavelength λ may be used for illuminating the resist layer, and the test pattern may have a maximum size equal to or smaller than λ/(2*NA). NA may be equal to or larger than e.g. 0.6, such as 0.7, 0.8. NA may be larger than 1.0, such as e.g. 1.2 or 1.4. In some applications, such as optical microscopes or extreme UV (EUV) tools, NA may be lower, such as in the range of 0.1-0.3. λ may be in the UV range, such as e.g. 365 nm, or in the deep UV range, such as e.g. 248 nm, 193 nm or 157 nm. λ may be in the EUV range, such as e.g. 13 nm. Ideal for the method would be an infinitely small test pattern, but because the test pattern should transmit sufficient light to form a detectable image, the opening should have a minimum size. In practice, an opening with a size substantially smaller than that corresponding to the resolution of the imaging system may be used. This size may be smaller than λ/2 NA), for example λ/(3NA). The opening may be round. For example, for λ=193 nm, NA=0.6 and a magnification M=¼, the diameter of the opening may be of the order of 500 nm, such as e.g. 600 nm or 200 nm.

The term isolated test pattern refers to a test pattern which is substantially free of so-called optical proximity effects. For such a pattern the aerial image is substantially independent of the aerial image of any adjacent image. Higher order radiation, i.e. radiation due to higher order geometrical aberrations, may be deflected over a distance up to 100 μm at substrate level. Higher order radiation is caused, for example, by imperfection of lens or mirror coatings, imperfections of lens materials and unwanted reflections at the object or at the detector. The isolated test pattern may have a distance to the adjacent pattern which is sufficiently large to prevent mixing of the higher order radiation originating from adjacent patterns. The required distance depends on the size of the higher order geometrical aberrations. The distance may be equal to or larger than 1 μm, such as 3 or 7 μm, preferably equal to or larger than 10 μm, such as 34 or 57 μm, or equal to or even larger than 100 μm, such as 155 μm. Preferably, the distance is below 100 μm.

In an embodiment a single test pattern is used because, according to this aspect of the invention, this suffices for determining the parameter relating to the image blur in the imaging system, whereas in the known method several different mask patterns of several different sizes have to be used. This renders the method according to the invention less complicated.

Because the test pattern has a size smaller than the resolution of the imaging system, the aerial image of the test pattern is substantially independent of the illuminator of the imaging system. The illuminator often has its own aberrations, such as e.g. astigmatism. The illuminator aberrations have to be taken into account in the known method where the test pattern is larger than the resolution of the imaging system, but can be neglected in the method according to the invention. The coherence value of the illuminator, often referred to as pupil fill factor, has to be taken into account in the known method where the test pattern is larger than the resolution of the imaging system, but it can be neglected in the method according to the invention. By using an isolated test pattern there are substantially no optical proximity effects to be taken into account in the method according to the invention, whereas such effects do occur in at least one in three pattern types used in the known method.

It is to be noted that the aerial image of an isolated test pattern having a size smaller than the resolution of the optical image system is not necessarily the aerial image with the smallest pattern size. Due to the optical proximity effects this is typically obtained by larger regular patterns, such as lines and spaces, as used in the known method. For these larger regular patterns the aerial image has the smallest images, so that the influence of the parameter relating to the image blur often is most readily visible. Therefore, it is common to use this type of pattern for the determination of the parameter.

According to the invention, deliberately a test pattern is chosen which results in a relatively large aerial image size. Contrary to what is expected the analysis of such a pattern is easier than the analysis of a pattern that corresponds to the smallest aerial image.

The method according to the invention is not limited to image blur relating to diffusion in the resist. It may be applied to determine a parameter relating to various types of image blur. Image blur is understood to be a blur of the image due to stochastic fluctuations among the components of the imaging system or due to stochastic fluctuations in the process of detecting the image. Both effects may be described using the same theory and will be explained below.

The method according to the invention is not limited to a lithographic system but may be applied to other types of imaging systems, such as e.g. optical microscopes or electron microscopes.

The method according to the invention is not limited to detection of the blurred image by means of a developed resist layer. The blurred image may be detected by detector means, which are referred to simply as the detector, and which may be an electronic device such as a CCD camera or by a photosensitive non-electronic detector such as a resist layer or a photographic paper. The detector may at least partly induce the blur of the image. When a resist layer is used, the parameter relating to the shape of the blurred image may be obtained by capturing the pattern formed in the resist layer by a scanning electron microscope (SEM) with digital image acquisition and storage capabilities. These images may be analyzed off-line.

The parameter relating to the shape of the blurred image may comprise a blurred point spread function (PSF). The blurred PSF may be obtained directly using e.g. an electronic detector such as a CCD camera. Alternatively, it may be reconstructed from a developed resist layer, e.g. from a focus exposure matrix or by interpolation of a single image to a presumed shape of the PSF. The step of determining the parameter relating to the image blur may comprise the step of fitting blurred intensity basic functions of the imaging system to the blurred point spread function. Geometrical aberrations of the imaging system may be accounted for conveniently by the intensity basic functions, given in equations 16 and 24 of the article “Aberration retrieval using the extended Nijboer-Zernike approach”, P. Dirksen, J. Braat, A. Janssen, C. Juffermans, Journal of Microlithography, Microfabrication and Microsystems, volume 2, issue 1, pages 61-68, January 2003, referred to simply as the reference in the remainder. The blurred intensity basic functions may be obtained by convoluting the intensity basic functions by a function accounting for the image blur. The convolution of each intensity basic function instead of the sum of the intensity basic functions is particularly advantageous when the amplitudes of the various intensity basic functions are to be determined.

In an embodiment a geometrical aberration of the imaging system is determined from the parameter relating to the shape of the test pattern formed. Geometrical aberrations of the imaging system may lead to additional blur of the image. The term geometrical aberration may refer to a single geometrical aberration such as e.g. the spherical aberration, coma, two-fold or three-fold astigmatism, or to a combination of several geometrical aberrations. The geometrical aberration may be described in terms of Zernike polynomials as described in the reference. The geometrical aberrations are understood not to include the chromatic aberration. The parameter relating to the image blur is understood not to include the geometrical aberration.

The inventors have gained the insight that the geometrical aberration may be determined independent of, but simultaneously with, the parameter relating to the image blur. This is an improvement with respect to known methods of determining the parameter, in which the geometrical aberration is usually neglected or assumed to be known, as well as with respect to known methods of determining the geometrical aberration, in which the parameter is usually neglected or assumed to be known. According to this aspect of the invention, both the process parameter and the geometrical aberration are determined accurately.

The imaging system may be a lithographic apparatus and the object may be a mask. The step of detecting the blurred image may comprise the steps of illuminating a resist layer by a blurred image, and developing the illuminated resist layer, thereby forming a pattern relating to the blurred image.

The resist layer may comprise a chemical component such as a photo acid generator which is activated by the illumination and which diffuses after the activation and before termination of the developing process, thereby changing the solubility of the resist layer. The process parameter may relate to the diffusion of the chemical component. In this embodiment the method may be used to determine the diffusion length of the chemical component in the resist. The diffusion may take place continuously starting just after the activation until the end of the development step. Alternatively, it may take place only during a portion of this time span, e.g. during a PEB only. The diffusion may be due to the diffusion of the acid, if present, and/or to the diffusion of other compounds such as the quencher, if present.

The method according to the invention is not limited to the determination of a parameter relating to the diffusion in the resist. It may be applied to more complex resist models which account for more than just the Fickian acid diffusion. The process parameter may relate to a non-Gaussian distribution function.

In an embodiment the step of forming a test pattern comprises forming a first test pattern at a first exposure dose and a second test pattern at a second exposure dose different from the first exposure dose. The exposure dose determines the amount of acid generated at the illuminated site. The higher the exposure dose, the more acid is generated. There is a certain threshold, i.e. a certain minimum amount of acid and thus a certain minimum number of photons or minimum intensity which is required to induce the solubility change of the resist. At the interface between the illuminated part of the resist and the non-illuminated part of the resist the intensity changes from a large value to a small value. This change depends on the geometrical aberration. By using different exposure doses this change is determined which allows for a more reliable determination of the geometrical aberration and the process parameter. More than two different exposure doses may be used such as e.g. three, five, six, seven or nine.

The method according to the invention is not limited to the determination of a parameter relating to the resist. It may be applied to determine a parameter relating to image blur which may be caused e.g. by mechanical noise inducing stochastic fluctuations of the position of the object with respect to the position of the detector. The stochastic fluctuations may be described by a Gaussian distribution or by another distribution function. The position of the object with respect to the detector may fluctuate in a direction perpendicular to the optical axis of the imaging system. The detector may include a resist layer. Such fluctuations may be anisotropic, i.e. different in two directions which are both parallel to the resist layer. This may occur e.g. in a step-scan lithography tool in which due to the stepping in one direction the noise may be larger than in another direction perpendicular to the scan direction.

The method according to the invention is not limited to the determination of a parameter relating to stochastic fluctuations of the position of the object with respect to the position of the detector in a direction perpendicular to the optical axis of the imaging system. The stochastic fluctuations may be described by a Gaussian distribution or by another distribution function. Such fluctuations may be in a direction parallel to the optical axis and may give rise to so-called focus noise. During the step of illuminating the object, an image of the test pattern is formed in an image plane. The position of the image plane depends on the position of the object and on the focal length of the projection system projecting the test pattern on the image plane. The detector may have an effective detector plane, i.e. a plane in which the blurred image is detected. When a resist layer is used as a detector, the resist layer may have a thickness of 500 nm or less, such as e.g. 300 nm, 200 nm or even less. The resist layer may be treated in approximation as if it were situated in a resist plane which is identical to the detector plane. The resist plane may be located in the middle of the resist layer and may be substantially perpendicular to the optical axis of the imaging system. The detector plane may not coincide with the image plane because of e.g. defocus. In such a case the image is broadened with respect to the aerial image in the image plane. The amount of broadening depends on the distance between the detector plane and the image plane, i.e. on the amount of defocus. This distance may be subject to stochastic fluctuations of various origin as will be discussed in the next paragraph. The parameter relating to the image blur determined by the method according to the invention may relate to the stochastic fluctuations of this distance between the image plane and the detector plane. The larger the stochastic fluctuations the larger the blur of the image.

The variations in the distance between the image plane and the detector plane may be caused by several mechanisms, such as e.g. mechanical vibrations of the object and/or the detector in a direction parallel to the optical axis. An alternative or additional cause of focus noise may be due to fluctuations of the wavelength of the illumination source used for illuminating the object. The imaging system may comprise a projector lens for projecting the image of the test pattern onto the detector. The projector lens may be chromatic, i.e. it may have a focal length which depends on the wavelength it focuses. In such a system, wavelength fluctuations of the illumination source may cause fluctuations of the distance between the image plane and the detector plane.

The parameter relating to the image blur may comprise two parameters, one relating to fluctuations in the detector plane which may be due to e.g. diffusion in the resist and/or due to mechanical fluctuations, and one relating to fluctuations perpendicular to the detector plane, e.g. due to focus noise. The inventors have gained the insight that the parameters describing these two processes can be disentangled in an embodiment of the method according to the invention.

In an embodiment, the parameter relating to the shape of the blurred image which is used for determining the parameter relating to the image blur, comprises the mean radius of the blurred image. In an ideal imaging system both the non-blurred image and the blurred image have a circular shape with different radius, the difference in the radii relating to the image blur. In a non-ideal imaging system, i.e. in an imaging system having a geometrical aberration, the non-blurred image and the blurred image may have a non-circular shape. This may be caused by geometrical aberrations such as e.g. coma, n-fold astigmatism, where n is an integer larger than one, and three-foil. This aspect of the invention is based on the insight that the mean radius of the blurred image is independent of most of the geometrical aberrations, including those referred to in the last sentence. This applies in general for all aberrations with m≠0 in the notation of the reference. Thus, when determining the parameter from the mean radius of the blurred image these aberrations do not have an influence on the value of the parameter.

The test pattern may be imaged at two different focus positions, i.e. the blurred image may be detected by the detector being situated in a detector plane, the image being formed in an image plane, a distance between the detector plane and the image plane being subject to stochastic fluctuations, the image blur relating to the stochastic fluctuations. When a resist layer is used as the detector, a first test pattern may be formed in the resist layer at a first distance between the resist plane and the image plane, and a second test pattern at a second distance between the resist plane and the image plane, the second distance being different from the first distance. The shape of the blurred image depends on the focus conditions at which it is formed. The geometrical aberration and the process parameter depend on the focus conditions in a different way. Thus, by detecting the blurred image at two different focus conditions, the geometrical aberration, such as e.g. the spherical aberration, and the parameter, such as e.g. the blur due to diffusion in the resist, can be disentangled in this embodiment.

Instead of just two focus conditions, three focus conditions, i.e. three distances between the detector plane and the image plane, may be used. One focus condition may be at best focus, i.e. the detector plane and the image plane coincide, one focus condition may be at under-focus, i.e. the image plane is below the detector plane, and one focus condition may be at over-focus, i.e. the image plane is above the detector plane. In this way a geometrical aberration and a parameter relating to the image blur which have different through focus characteristics, such as e.g. the spherical aberration and a stochastic fluctuation in or perpendicular to the detector plane, may be readily disentangled.

The number of different focus conditions may be larger than three, such as e.g. five, six, seven or nine. The number of different focus conditions may be 2N+1, N being a positive integer, with one focus condition being best focus, N focus conditions being under-focus and N focus conditions being over-focus.

When a resist layer is used as the detector, for each focus condition different exposure doses may be used. In this way a so called focus exposure matrix is obtained which allows for a stable fit of the process parameter and the geometrical aberration, if fitted as well.

These and other aspects of the invention will be further elucidated and described with reference to the drawings, in which:

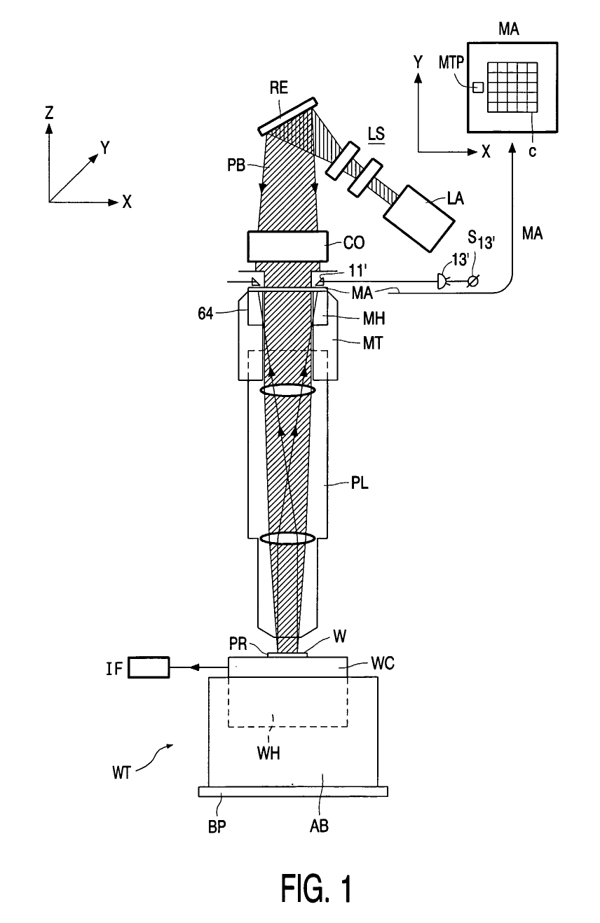

FIG. 1 shows diagrammatically an embodiment of an imaging system with which the step of illuminating the object is performed;

FIGS. 2A and 2B show a test pattern on a mask and a test pattern in the resist layer after the development step, respectively;

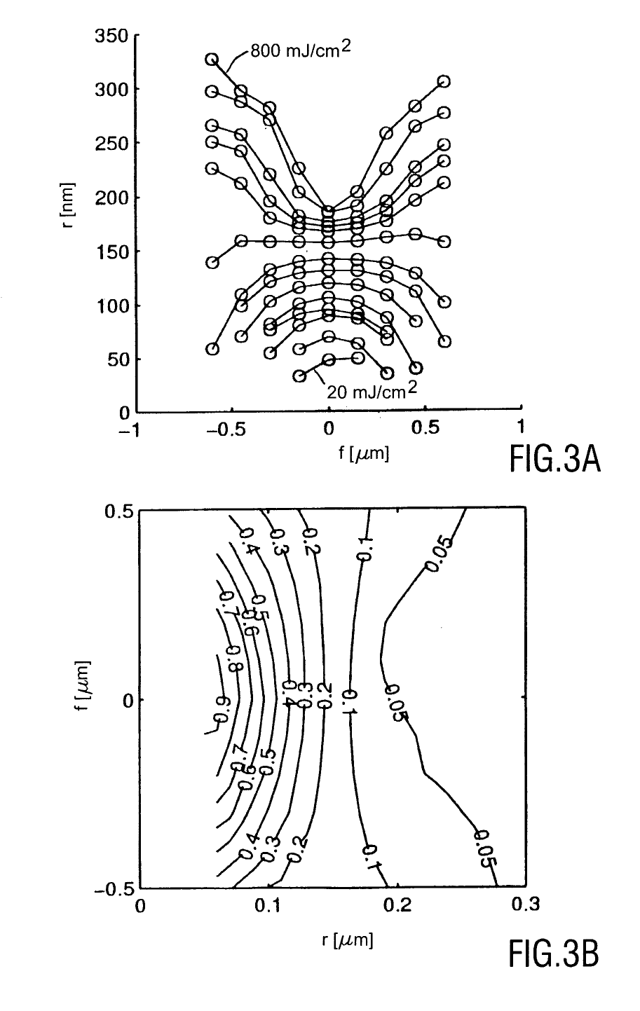

FIGS. 3A and 3B show the focus exposure matrix and the point spread function derived thereof, respectively;

FIGS. 4A-4C show ideal the point spread function together with the point spread function in the presence of spherical aberration, diffusion in the resist plane and stochastic fluctuations perpendicular to the resist plane, respectively; and

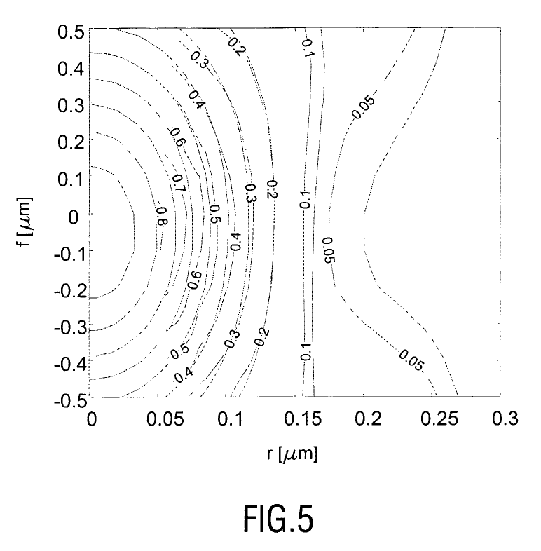

FIG. 5 shows a fit of the point spread function to determine the process parameters.

FIG. 1 shows diagrammatically the most important optical elements of an embodiment of an imaging system IS which is a lithographic apparatus for repetitively imaging a mask pattern on a substrate. This apparatus comprises a projection column accommodating a projection lens system PL. Arranged above this system is a mask holder MH for accommodating a mask MA in which the mask pattern C, for example, an IC pattern to be imaged is provided. The mask holder is present in a mask table MT. A substrate table WT is arranged under the projection lens system PL in the projection column. This substrate table supports the substrate holder WH for accommodating a substrate W, for example, a semiconductor substrate, also referred to as wafer. This substrate is provided with a radiation-sensitive layer, referred to as resist layer PR on which the mask pattern must be imaged a number of times, each time in a different IC area Wd. The substrate table is movable in the X and Y directions as indicated in the Figure so that, after imaging the mask pattern on an IC area, a subsequent IC area can be positioned under the mask pattern.

The apparatus further comprises an illumination system, which is provided with an illumination source LA. The illumination source LA is an excimer laser operating at λ=193 nm, but may be alternatively any other suited energy source, such as e.g. a krypton-fluoride excimer laser or a mercury lamp. The apparatus further comprises a lens system LS, a reflector RE and a condenser lens CO. The projection beam PB supplied by the illumination system illuminates the mask pattern C. This pattern is imaged by the projection lens system PL on an IC area of the substrate W. The illumination system may be implemented as described in EP-A 0 658 810. The projection system has, for example, a magnification M=¼, a numerical aperture NA=0.63 and a diffraction-limited image field with a diameter of 22 mm.

The projection apparatus further comprises a focus error detection device, not shown in FIG. 1, for detecting a deviation between the focal plane and the projection lens system PL and the plane of the resist layer PR. Such a deviation may be corrected by moving, for example, the lens system and the substrate with respect to each other in the Z direction or by moving one or more lens elements of the projection lens system in the Z direction. Such a detection device, which may be fixed, for example, to the projection lens system, is described in U.S. Pat. No. 4,356,392. A detection device with which both a focus error and a local tilt of the substrate can be detected is described in U.S. Pat. No. 5,191,200.

Very stringent requirements are imposed on the projection lens system. Details having a line width of, for example 0.35 μm or smaller, should still be sharply imaged with this system, so that the system must have a relatively large NA, for example, larger than 0.6. Moreover, this system must have a relatively large, well-corrected image field, for example, with a diameter of 23 mm. To be able to comply with these stringent requirements, the projection lens system comprises a large number, for example tens, of lens elements. Each of these lens elements must be made very accurately and the system must be assembled very accurately. A good method of determining whether aberrations of the projection system are small enough to render this system suitable to be built into a projection apparatus, as well as to allow detection of aberrations during the lifetime of the apparatus, is valuable and provided in one embodiment of the method according to the invention. The latter aberrations may have different causes. Once the aberrations and their magnitudes are known, measures can be taken to compensate for them, for example by adapting the position of lens elements or the pressure in compartments of the projection system.

The method of determining a parameter relating to image blur comprises the step of illuminating the mask MA, which is the object and which has a test pattern MTP, by means of the imaging system IS. The mask test pattern MTP is an approximately round opening with a diameter of 0.6 μm and has a size smaller than the resolution of the imaging system IS, which is approximately λ/(NA*M)=1.2 μm. The test pattern is an isolated pattern. It is shown in FIG. 2A. The distance to the next, adjacent pattern on the mask MA is 25 μm. The mask MA may comprise, in addition to the mask test pattern MPT, a pattern C which is used to produce a corresponding chip pattern in the resist layer PR. A qualified reticle, i.e. a reticle with a test pattern of which the diameter is known from for example SEM measurement, may be used as the mask MA.

A semiconductor wafer WA coated with an anti reflection coating and the resist layer PR is subjected to a soft bake and serves as a detector. Details of the procedure may be found in the reference. The wafer WA may be a product wafer in a production step and may contain a stack of interference layers or antireflection coatings of for example SiON.

The resist layer PR is AR237 from JSR (Japanese Synthetic Rubber corp.) and has a thickness of 100-500 nm. The invention is not restricted to a resist layer as a detector nor to this resist nor to this resist thickness. Different portions of the resist layer PR are illuminated with different exposure doses and with different focus conditions. The portions of the resist layer PR are arranged in a matrix structure where test patterns in the same column have the same exposure dose, and test patterns in the same row have the same focus condition. The exposure doses were relatively large compared to normal production doses and ranged typically between 10 and 1000 mJ/cm². 20 different doses were used. The dose sampling was usually non-equidistant. The doses of adjacent curves were chosen such that the difference of the inverse of the doses is approximately constant. The largest dose corresponds to roughly the 1-5% contour of the intensity point spread function. Exposure time was about 10 minutes. This implies that the step of forming a test pattern comprises forming a first test pattern at a first exposure dose and a second test pattern at a second exposure dose different from the first exposure dose.

The focus conditions were typically from 1.0 μm under-focus to 1 μm over-focus in 11 equidistant steps, i.e. with 0.1 μm focus increments. This implies that during the step of illuminating the resist layer an image of the mask pattern is formed in an image plane, the resist layer being situated in a resist plane, the step of forming a test pattern comprising forming a first test pattern at a first distance between the resist plane and the image plane, and a second test pattern at a second distance between the resist plane and the image plane, the second distance being different from the first distance. Thus 11 times 20, i.e. 220 different test patterns were obtained. One of the test patterns thus obtained is shown in FIG. 2B. It is a blurred image of the test pattern. The blurring is caused by stochastic processes discussed below. For each exposure, the exposure dose, i.e. the energy used, and the focus conditions are stored in an electronic file together with the position of the corresponding test pattern on the wafer WA.

In FIG. 5 of the reference an example is shown with an exposure of the mask test pattern at non-ideal focus condition and non-ideal exposure dose, together with reference exposures which always take place at the same, nominal conditions of best focus and best dose. These patterns are produced in an additional exposure step and may be used for pattern recognition in the SEM, in particular when the analysis includes non-rotationally symmetrical terms.

The illuminated resist layer PR is developed, thereby forming a test pattern. The development is done using a PEB of 130 degrees Celsius and 90 seconds duration, and OPD 262 from Arch Chemicals as a development agent. As a result of this step a matrix of test patterns is obtained, each having a shape similar to that shown in FIG. 2B. In the test pattern shown in FIG. 2B the resist layer PR has a hole which exposes the underlying wafer WA. At the interface between the resist layer PR, which in this image appears light gray, and the exposed wafer WA, which in this image appears dark gray, there is a light ring indicating the inner surface of the opening in the resist layer PR. The images of the test patterns in the matrix are obtained by a Hitachi 9200 scanning electron microscope (SEM) using a magnification of 100,000 times when no reference patterns are used. With reference patterns the magnification is about 30,000. The energy of the electrons was 800-500 eV. The images of the various test patterns are obtained by the SEM and stored in a computer. The stored file may include additional information such as the exact position and the magnification. The data collection may be automated or manual.

On this set of images a data reduction is performed to extract a parameter relating to the shape of the test pattern, which will be used later on to determine the process parameter. This data reduction may be performed either on the SEM or off-line. In this step the shape of each test pattern, i.e. in this example of each contact hole image, is derived from the image. The algorithm may be a simple threshold algorithm or a more sophisticated algorithm involving the differential of the image. The latter detects the locations of the steepest intensity variation in the SEM image and is a robust algorithm to detect the shape of the contact hole. From the shape, parameters like the diameter or the mean radius, which may be obtained by a least square fitting procedure, and optionally the eccentricity, i.e. the difference between the central coordinate according to the fitting procedure and the ideal coordinate, may be extracted. Each image may receive a quality number representing the quality of the images. Low quality images may be rejected from the analysis. For instance a certain minimum contrast of the SEM image may be required. Alternatively, or in addition, it may be required that the contour is closed, and/or that the diameter or the mean radius is within certain limits such as e.g. between 40 nm and 400 nm. If one or several of these conditions is not met, the image may be rejected.

As a result of the data reduction step, a collection of parameters relating to the shapes is obtained for each point of the focus exposure matrix. The parameter relating to the shape may be the shape as derived by one of the algorithms described in the previous paragraph and/or e.g. the diameter or the mean radius. When no geometrical aberrations are determined or when only rotationally symmetric geometric aberrations are determined, the mean radius suffices for the further method steps. The extension to include non-rotationally symmetric geometric aberrations is analogous to the procedure described in the reference. It is straightforward and does not need to be described in detail here.

Using the exposure data, the mean radii may be related to the exposure dose and the focus conditions. The mean radii may be translated to the raw point spread function (PSF), i.e. to the intensity as a function of the radius and the focus, using the relation that the intensity is proportional to 1/dose. In this step, data of adjacent doses may be interpolated in a quadratic way to reduce the data while improving the signal to noise. In FIG. 3A, the data are plotted as a function of the radius R and the focus f for fixed exposure doses between 20 mJ/cm² and 800 mJ/cm². In FIG. 3B the corresponding data are plotted after the transformation from doses to intensity as a function of the focus f and the radius R for fixed relative intensities, normalized to 1 at the maximum.

There may be some data points missing, as there may be a minimum diameter of the test pattern which can be printed into the resist layer, for example a diameter of 100 nm. Smaller diameters may not occur. The missing data points represent a “hole” in the PSF at R<50 nm. The missing data points may be ignored and removed from the data set prior to the subsequent analysis. Alternatively, a flat top of the PSF may be assumed, i.e. the intensity is assumed to be constant for R<50 nm, or the intensity for 0<R<100 nm may be extrapolated using basic functions from the extended Nijboer Zernike (ENZ) theory, described in the reference. After one of these steps, the ‘clean point-spread function’ I(r, f), hereafter simply referred to as the PSF, is obtained which is shown in FIG. 3B.

The PSF is described by an improved version of the ENZ theory, which is an extension of the ENZ theory as presented in the reference and which will be described below. Before the analysis of the experimentally obtained data as e.g. shown in FIG. 3B is described, the influence of process parameters due to diffusion of resist, due to stochastic fluctuations of the distance between the resist plane and the image plane, and due to geometrical aberrations is analyzed by simulations.

In the absence of any geometrical aberration and any process parameter, the PSF is given by the first term on the right hand side of equation 24 of the reference. This is the ideal PSF which is shown in the counter plots of FIGS. 4A-4C by a solid line.

When the imaging system has spherical aberration, the PSF is the sum of the ideal PSF plus a term 2Im{β₄₀}Re{iV*₀₀V₄₀}. Here and in the remainder of the description, an * indicates the complex conjugate and all variables are defined in the reference. In FIG. 4A the PSF in the presence of spherical aberration is shown by a dashed line. The other process parameters are assumed to be absent. It is shown that spherical aberration causes a through-focus asymmetry of the PSF, i.e. I(r,f)≠I(r,−f).

When a process parameter relating to a diffusion process in the resist plane has to be taken into account, the PSF obeys approximately the well-known Fickian two-dimensional diffusion equation. The first order expansion of the diffusion equation with respect to time involves the second derivative to the position. The second derivative of all basic intensity functions with index (n,m) can be calculated explicitly. For the aberration-free part (m=n=0, thus V₀₀²) this yields, in first order of t, an additional term in the PSF, which is:

−π²σᵣ²(V₂₀V*₀₀+V*₂₀+2V₀₀V*₀₀−4V₁₁V*₁₁).

Here, σᵣ is a measure for the diffusion length. It may relate to the acid diffusion coefficient D and the time t during which the diffusion takes place, as σᵣ=√(2Dt). This term is to be added to the ideal PSF and to the spherical aberration term, if present. If the image blur originates from mechanical noise in the horizontal plane, σᵣ is interpreted as the RMS-noise amplitude of this mechanical noise. If both diffusion and position noise are present, a total RMS amplitude may be defined which is represented by a single parameter σᵣ, which is equal to the square root of the sum of the squares of the two individual parameters. Also the second order term, i.e. proportional to t² or σ⁴, can be calculated explicitly and may be used to describe the effects of larger values of the diffusion coefficients. This term involves the fourth derivative to the position.

In the above described model, it has been assumed that the diffusion process is isotropic. In the case that the diffusion process has two different diffusion length parameters σₓ and σ_{y}, corresponding to the X- and Y-direction, the σᵣ² should be replaced by σᵣ²=½(σₓ²+σ_{y}²), while a further correction is added to the PSF:

0.5π²(σₓ²−σ_{y}²)[2V₂₂V*₀₀+2V₀₀V*₂₂+4V₁₁V*₁₁]cos(2φ).

Thus a second harmonic m=2 intensity term has to be added to the PSF. The effect of anisotropic diffusion or position noise is an elliptical deformation of the PSF that is even through focus, i.e. I(r,f)=I(r,−f). The anisotropic parameters may be retrieved by considering the m=2 transmission terms in a way very similar to that described in the reference.

Alternatively, a 2D convolution of the PSF in the position variables x and y by a 2D Gaussian distribution function with standard deviation σₓ, σ_{y} may be calculated. In first order, this results in the correction stated analytically above.

It may be necessary to rotate the above additional correction term for anisotropy so as to account for diffusion processes having orthogonal symmetry axes that do not necessarily coincide with the canonical X-and Y-axis of the given optical system.

In FIG. 4B, the PSF in the presence of diffusion in the detector plane is shown by a dashed line. The other process parameters and geometrical aberration are assumed to be absent. It is shown that the diffusion in the detector plane causes a broadening of the PSF in the radial direction whereas the PSF in the focal direction is almost unchanged. It should be noted that the PSF in the presence of diffusion only is symmetric through focus, i.e. PSF(f)=PSF(−f).

It should be noted that the theory for diffusion in the resist plane applies to the diffusion of the acid in the resist, if present, as well as to isotropic stochastic fluctuations in the resist plane which may be due to e.g. mechanic vibrations or synchronization errors in case of a wafer scanner.

A parameter relating to position fluctuations perpendicular to the detector plane may also be taken into account The focus parameter f is considered as a stochastic variable. Although not essential, we assume for simplicity that f has a symmetrical distribution around its mean with standard deviation σ_{f}. Then the expectation value of basic intensity functions involves essentially the second derivative of the basic intensity functions to the focus parameter. The second derivative with respect to the focus parameter can be calculated explicitly for all (n,m)-values. In the aberration-free case (m=n=0), focus noise may be included by an additional term in the PSF, which is:

−0.5σ_{f}²(⅙|V₀₀|²−½|V₂₀|²+⅙V₀₀V*₄₀+⅙V₄₀V*₀₀).

Alternatively, a 1D convolution of the PSF in the focus variable f by a 1D Gaussian distribution function with standard deviation σ_{f} may be calculated. In first order, this results in the correction stated analytically above.

Here, σ_{f} is a measure for the stochastic fluctuations in the distance between the detector plane and the image plane. This term is to be added to the ideal PSF, the spherical aberration term, if present, and to the diffusion term in the detector plane, if present.

In FIG. 4C, the PSF in the presence of stochastic fluctuations perpendicular to the resist plane is shown by a dashed line. The other process parameters and geometrical aberration are assumed to be absent. It is shown that focus noise, i.e. position noise perpendicular to the detector plane, causes a broadening of the PSF in the focal direction whereas the PSF in the radial direction is almost unchanged. It should be noted that the PSF in the presence of focus noise only is symmetric through focus, i.e. PSF(f)=PSF(−f) for a symmetrical distribution of f.

FIGS. 4A-4C demonstrate that the geometrical aberration, the process parameter due to diffusion in the resist plane and the process parameter due to fluctuations perpendicular to the resist plane have a distinctively different effect on the PSF. Therefore, they can be disentangled in the same experiment. Alternatively, the geometrical aberration may be determined in a separate experiment where a detector is used instead of the resist layer, as is described in the international patent application WO 03/056392.

The inventors have gained the insight that the different process parameters and the geometrical aberrations can be separated even when higher-order terms are taken into account. In the presence of geometrical aberrations, the PSF may be expressed as a linear sum of so-called intensity basic functions, given in equations 16 and 24 of the reference. The blur of the PSF due to the process parameter is assumed to be an at least by approximation linear process.

Therefore, the process parameter may be obtained by simply fitting the PSF to the terms simulated in one or more of the FIGS. 4A-4C and described above. When the geometric aberration and/or the diffusion and/or the stochastic fluctuations are relatively large, a more accurate way to determine the process parameter and the geometric aberration is the following: first the intensity basic functions are calculated using the Bessel representation for the Vₙₘ polynomials, see equation 6 of the reference. When the finite size of the test mask pattern is taken into account, i.e. the test mask pattern of the same order as the resolution of the imaging system, equation 11 of the reference has to be used instead. The results for Vₙₘ are stored in an electronic data file. Next, the intensity basic functions Ψ^{m}ₙ(r, f) and χ^{m}ₙ(r, f) are calculated according to the equations 16 or equation 24 of the reference, depending on the size of the test mask pattern. When transmission errors in the pupil of the imaging system are neglected, χ^{m}ₙ(r, f) can be neglected in the analysis. Again the results may be electronically stored into a data file.

Next, each basic intensity function Ψ^{m}ₙ(r, f) thus obtained is convoluted with a term accounting for the process parameter. The result of this step is a corresponding set of diffused basic intensity functions Ψ^{m}ₙ(r, f). In case of diffusion in the resist plane and stochastic fluctuations perpendicular to the resist plane, these operations are described as 2D and 1D convolution operations in the horizontal plane and along the focus axis, respectively. When the diffusion and the fluctuations are assumed to be a Gaussian process, the basic intensity functions Ψ^{m}ₙ(r, f) are convoluted with a term d(r)=2/σᵣ² exp{−r²/(2σᵣ²)} and a term g(f)=1/(σᵣ√(2π))exp{−f²/(2σ_{f}²)}, respectively. The diffused basic intensity functions are calculated for a set of possible process parameters. The operation may require a significant CPU time of more than one hour if done by numeric integration, but fortunately it needs to be done only one time, i.e. once for each setting of λ and NA. For small process parameter values the analytical formulas given above may be used. The advantage of the analytical formulas is their stability and ease of computation. For small parameter values, the numerical calculation may suffer from discretization problems as the convolution kernels are very narrow and require a very fine grid to do the numerical calculations with sufficient accuracy.

As a result of this step, a large table of diffused intensity basic functions is obtained for each value of the process parameter σᵣ and σ_{f}, for example for σᵣ in the range between 0 and 50 nm for every 2 nm, and for of in the range between 0 and 300 nm for every 5 nm.

In an embodiment only rotationally symmetric terms are considered. The size of the data base is then relatively small. It may consist of terms corresponding to the Z4 (defocus) and Z9, Z16 Zernike polynomials, see the reference and the references cited therein for a definition of the Zernike polynomials. Initially, this results in 6 intensity basic functions describing both the phase and transmission errors. Applying the resist model and focus noise we now have 26*61*6=9516 basic functions. Alternatively, one can choose to use a ‘hybrid solution’ where the diffusion is calculated numerically, which allows for a relatively large diffusion length, and the results for the diffusion are stored in a data file, but the impact of focus noise is calculated analytically “on the fly”. The result is a significant reduction in data size at the cost of a mild amount of CPU time and accuracy. Each time a process parameter of a lithography process is analyzed, the same database of the diffused intensity basic functions is used, provided the same settings of λ and NA apply, thereby saving CPU time.

In a next step of determining the process parameter from a parameter relating to the shape of the test pattern, a computer program is used which executes the following steps: first the data base with all the basic intensity functions is loaded for all possible values of σᵣ and σ_{f}. For each combination of σᵣ and σ_{f} the beta-coefficients βₙₘ, see e.g. equation 24 of the reference, are determined by a least square fitting procedure in a way analogous to what is described in section 2 and 3 of the reference.

For each combination of σᵣ and σ_{f} the beta-coefficients βₙₘ thus determined are used to calculate the figure of merit M which is defined as:

$$M ( {σ}_{r} , {σ}_{f} ) = \frac{{\sum }_{p \neq 0}^{ } \frac{1}{2 ( 2 p + 1 )} {( Re ( {β}_{2 p 0} ) )}^{2}}{{\sum }_{p} \frac{1}{2 ( 2 p + 1 )} [ {( Re ( {β}_{2 p 0} ) )}^{2} + {( Im ( {β}_{2 p 0} ) )}^{2} ]}$$

The values of σᵣ and σ_{f} for which the figure of merit M reaches its minimum value are the process parameters. The figure of merit is particularly useful for mask test patterns which have a size smaller than the resolution of the imaging system. It is assumed that the transmission errors of the lens can be neglected and that the phase errors are non-neglectable, but small. Accordingly, within the notation of the reference, A=1 and Re(β₂ₚ₀) practically vanishes. For the anisotropic case we may define a figure of merit M(σₓ,σ_{y}σ_{f}) similar to the figure of merit defined above. However, now we also consider the real and imaginary Beta terms with m=2, and again optimize the values σₓ,σ_{y},σ_{f} for which M reaches a minimum.

Alternatively, in particular when the terms χ^{m}ₙ(r, f) are omitted in the analysis, instead of the figure of merit a simple least square fitting procedure may be applied and directly retrieve the σᵣ and σ_{f} parameters or more general the values of σₓ,σ_{y},σ_{f}.

Using the pre-calculated database as described above, the entire analysis procedure takes typically 10-15 minutes, including the analysis of approximately 200 SEM images.

In FIG. 5, the PSF as obtained from the focus exposure matrix as described above is shown as a solid line. The result of the fitting procedure described above is shown by dashed lines. The results of the fitting procedure are a spherical aberration coefficient of 34 mλ, a σᵣ of 31 nm and a σ_{f} of 195 nm. The RMS fit error is typically 1.5%.

During the fitting procedure, the geometric aberration and/or σᵣ or σ_{f} may be bound to be zero, in particular when the corresponding contribution to the blur of the PSF is small or is assumed to be small.

The parameter or parameters thus obtained may be used to optimize the chemical composition of the resist, the development of the resist, the stepper or scanner performance such as synchronization settings and tuning of the laser. Tests may be carried out by the vendor of a lithography tool or on a production tool during maintenance.

The parameters thus obtained may be used in a lithography simulator for process optimization, e.g. optimization of the exposure conditions or of mask design and manufacture; in particular for optical proximity correction masks this may be advantageous. To this end a desired mask pattern may be provided, the parameter relating to the image blur may be determined by means of the method described above, and the mask pattern may be calculated from the desired mask pattern and the parameter relating to the image blur, thereby obtaining the designed mask pattern.

In another embodiment of the method, a CCD array is used as a detector instead of the resist layer. This detector may be an integral part of the lithographic system, e.g. it may be integrated in the wafer holder WH. Alternatively it may be provided at the position otherwise occupied by the wafer WA. In this case the method according to the invention allows for determining a parameter relating to image blur caused e.g. by mechanical vibrations of the detector with respect to the mask. The image blur may also be caused at in least in part by vibrations of the optical components of the imaging system.

Instead of a lithographic system, the imaging system may be e.g. an optical or electron microscope. The stochastic fluctuations may be caused by stochastic fluctuations between the position of the object, the detector, and/or the optical components. In this way the performance of the imaging system may be characterized.

Even when the imaging system is not a lithographic system but e.g. an optical microscope, the detector may comprise a resist layer. This may allow for the determination of a parameter relating to image blur due to the diffusion processes in the resist, without a relatively expensive stepper being required.

In summary, the method of determining a parameter relating to image blur in an imaging system IS comprising the step of illuminating an object having a test pattern by means of the imaging system, thereby forming an image of the test pattern. The test pattern has a size smaller than the resolution of the imaging system, which makes the image of the test pattern independent of illuminator aberrations. The test pattern is an isolated pattern, which causes the image to be free of optical proximity effects. The image is blurred due to stochastic fluctuations in the imaging system and/or in the detector detecting the blurred image. The parameter relating to the image blur is determined from a parameter relating to the shape of the blurred image. According to the invention, resist diffusion and/or focus noise may be characterized. In the method of designing a mask, the parameter relating to the image blur due to diffusion in the resist is taken into account. The computer program according to the invention is able to execute the step of determining the parameter relating to the image blur from a parameter relating to a shape of the blurred image.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

1. Method of determining a parameter relating to image blur in an imaging system (IS), the method comprising the steps of:
illuminating an object having a test pattern (MTP) by means of the imaging system (IS), thereby forming an image of the test pattern, the test pattern (MTP) having a size smaller than a resolution of the imaging system (IS), the test pattern (MTP) being an isolated test pattern, the image being blurred,
detecting the blurred image, and
determining the parameter relating to the image blur from a parameter relating to a shape of the blurred image.

2. Method as claimed in claim 1, wherein the parameter relating to the shape of the blurred image comprises a blurred point spread function, and the step of determining the parameter relating to the image blur comprises the step of fitting blurred intensity basic functions of the imaging system (IS) to the blurred point spread function.

3. Method as claimed in claim 2, wherein the step of fitting blurred intensity basic functions of the imaging system (IS) to the blurred point spread function comprises the steps of:
calculating sets of blurred intensity basic functions for a set of parameters relating to the image blur, and
fitting for each of the parameters relating to the image blur the corresponding set of blurred intensity functions to the blurred point spread function.

4. Method as claimed in claim 1, wherein a geometrical aberration of the imaging system (IS) is determined from the parameter relating to the shape of the blurred image.

5. Method as claimed in claim 1, wherein the blurred image is detected by detector means (PR) being situated in a detector plane, the image being formed in an image plane, a distance between the detector plane and the image plane being subject to stochastic fluctuations, the image blur relating to the stochastic fluctuations.

6. Method as claimed in claim 1, wherein the parameter relating to the shape of the blurred image comprises a mean radius thereof.

7. Method as claimed in claim 1, wherein the imaging system (IS) is a lithographic apparatus, the object is a mask (MA), and the step of detecting the blurred image comprises the steps of illuminating a resist layer (PR) by an image of the test pattern (MTP), and developing the illuminated resist layer, thereby forming a pattern relating to the blurred image.

8. Method as claimed in claim 7, wherein the resist layer (PR) comprises a chemical component which is activated by the illumination and which diffuses after the activation and before the development, the chemical component changing a solubility of the resist layer, the image blur relating to the diffusion of the chemical component.

9. Method as claimed in claim 7, wherein the step of illuminating the resist layer is executed at a first exposure dose and at a second exposure dose different from the first exposure dose.

10. Method of designing a mask pattern for use in a lithography process, comprising the steps of:
providing a desired mask pattern,
determining the parameter by means of the method according to claim 7, and
calculating the mask pattern from the desired mask pattern and the parameter, thereby obtaining the designed mask pattern.

11. Computer program for use in the method as claimed in claim 1, the computer program comprising instructions for causing a programmed device to execute the step of determining the parameter relating to the image blur from a parameter relating to a shape of the blurred image.

12. Device for determining a parameter relating to image blur in an imaging system (IS), the device comprising means for determining the parameter relating to the image blur from a parameter relating to a shape of the blurred image.
